(19) United States
(12) Patent Application Publication
(10) Pub. No.: US 2010/0266743 A1
(43) Pub. Date: Oct. 21, 2010

(54) AGGLOMERATION OF STARCH

(76) Inventors: Zhenghong Chen, Foxhol (NL); Pieter Lykle Buwalda, Groningen (NL)

Correspondence Address: HOFFMANN & BARON, LLP, 6900 JERICHO TURNPIKE, SYOSSET, NY, 11791, US

(21) Appl. No.: 12/747,201

(22) PCT Filed: Dec. 10, 2008
(86) PCT No.: PCT/NL2008/050789

§ 371 Date: Jun. 10, 2010

(30) Foreign Application Priority Data
Dec. 10, 2007 (EP) 07122714.4

(51) Int. Cl. A23L 1/0522; C08B 31/00; C08B 31/18; A21D 13/00; A21D 8/00; A23L 1/187; A23L 1/40

(52) U.S. Cl. 426/549; 536/102; 536/105; 536/106; 426/496; 426/579; 426/589; 426/578

(57) ABSTRACT

The invention is directed to a method for agglomerating starch, to starch obtainable by said method, to a food product comprising said starch, and to the use of said starch. The method of the invention comprises the mixing of starch with an aqueous solution comprising a salt and drying the mixture.

The invention is directed to a method for agglomerating starch, to starch obtainable by said method, to a food product comprising said starch, and to the use of said starch.

Starch and starch derivatives are multifunctional components employed in a wide variety of food products such as bakery creams, instant noodles, soups, dry mixes, meat, etc. The starch is usually imparted to enhance the nutritional value, to improve the taste and/or to give the product the desired viscosity and texture.

The application of starch or derivatives thereof in food products is by no means straightforward. One of the problems is the so-called lumping. Part of the starch component sticks together in the process, which gives rise to lumps. These lumps in turn are perceived by the end consumer as disagreeable and unwanted. Another problem is the possible demixing of starch with other dry components, such as salt, spices, herbs, etc. Further problems are encountered in the flow properties of starch in dosing the material from packaging and, more importantly, from silos in factories.

Part of these problems can be solved by agglomerating the starch or derivates thereof.

EP-A-1 166 645 describes the preparation of an agglomerated starch product using sugar, maltodextrin or cold soluble starch. The random distribution of maltodextrin in the agglomerated starch product is said to avoid the lumping problem. The products are free flowing, which eases the dosing to food systems. This method, however, does not avoid demixing of the starch with components that have a higher density, such as salt. In addition, the viscosity decreases significantly due to the addition of maltodextrin or cold soluble starch.

U.S. Pat. No. 7,186,293 describes the preparation of an agglomerated starch composition either by fluidizing a mixture comprising native starch and pre-compacted starch powder and spraying a slurry comprising pre-compacted starch powder onto the fluidised mixture, or by producing an aqueous slurry of pre-compacted starch powder and native starch followed by spray drying the slurry. The obtained agglomerated starch is said to have improved flow properties. This method however requires the extra step of first preparing pre-compacted starch powder.

It is an object of the invention to provide a simple method for preparing agglomerated starch.

A further object of the invention is to provide a method for preparing agglomerated starch which avoids, or at least reduces, the formation of lumps during processing.

Yet a further object of the invention is to provide a method for preparing agglomerated starch, which does not demix and/or segregate, or only demixes and/or segregates to a lesser extent, with other dry components.

Another object of the invention is to provide a method for preparing agglomerated starch, having increased flow properties.

The inventors surprisingly found that one or more of these objects can be met by the provision of a method in which starch is agglomerated by a salt.

Accordingly, in a first aspect the invention is directed to a method for the preparation of agglomerated starch, comprising

mixing of starch with a salt and water; and

drying the mixture.

Without wishing to be bound by theory, the inventors believe that, after mixing and drying, the dehydrated salt forms a crystal which binds the starch granules. The salt crystals form a layer around single starch granules where the salt binds. In this manner a starch/salt agglomerate can be formed. When water is applied to such agglomerated starch, the salt assists the starch in dissolving properly.

The starch agglomerates of the invention can advantageously be applied in salty food products, such as instant soups and meat. These advantages include that the starch aggregates dissolve lump free and that the salt and the starch do not or hardly demix and the end user can employ the agglomerated starch/salt mix in one go causing less error and less storage costs. In addition, the products are free flowing.

Application of the agglomerated starch of the invention is very convenient. Soup, for instance, in most cases has a salty taste. When preparing a soup formula, the addition of salt is therefore often a necessary step. However, if the starch and salt are just mixed, it is difficult to get a homogeneous blend, because during packing the starch, salt and other ingredients separate due to the different densities of the ingredients. The addition of agglomerated starch overcomes this disadvantage of the prior art.

The inventors are not aware of any earlier publication describing the agglomeration of starch using salt. JP-A-59 066 858 describes the granulation of KCl or a mixture of KCl and NaCl with a binder such as carboxymethyl cellulose or soluble starch. Such granulation is said to prevent the agglomeration of the salt. The starch in this Japanese patent application merely serves to accommodate the granulation of the salt composition.

Starch is the reserve carbohydrate deposited in seed kernels, stems, roots and tubers. Starch usually consists of two components: linear α(1-4)D-glucan polymer (branching is found at a low level) called amylose and an elaborately branched α(1-4 and 1-6)D-glucan polymer called amylopectin.

For the method of the invention, native starch as well as their derivatives can be used. The starch can suitably originate from roots, tubers, cereals, legumes, or can be isolated from other plants. The starch can for instance originate from maize, barley, wheat, rice, triticale, millet, tapioca, arrow root, banana, potato, sweet potato, legumes, sago, etc. Due to their high viscosity, potato starch and its derivatives are preferred.

In a specific embodiment a high amylose starch (amylose content higher than 30%), such as amylomaize starch, mung bean starch, pea starches, high amylose potato starch, or a combination thereof is employed. These high amylose starches may be derived from plants that preferentially produce amylose through natural processes, but can also be obtained by genetically modifying plants.

In a further embodiment so-called waxy starches are employed. These starches consist for more than 93 wt. % of amylopectin. Well-known examples of waxy starches that can be used in the invention are waxy maize starch, waxy wheat starch, waxy barley starch, waxy sorghum starch, waxy rice starch, waxy potato starch, and waxy tapioca starch. These high amylopectin starches may be derived from plants that preferentially produce amylopectin through natural processes, but can also be obtained by genetically modifying plants.

Also starch derivatives may be used in the invention. The skilled person is familiar with many ways of derivatizing (O. B. Wurzburg (Ed.), “Modified Starches: Properties and Uses”, CRC Press Inc., Boca Eaton, Fla., 1986). Derivatives for instance include chemically modified starch, physically modified starch including regelatinised starch, enzymatic modified starch, and biotechnologically modified starch. Examples of derivatizations encompass crosslinking, enzymatic degradation, acid degradation, oxidation, etherification, esterification, dry roasting, and dextrinization.

Physical treatments can also render starch different functionalities. Drum drying, spray cooking and extrusion will make starch cold water soluble. A special physical treatment is described in patent EP-B-0 804 488. In a dry heating process the starch is physically cross-linked, i.e. gives the product properties of chemically cross-linked starch without adding chemicals (thermal inhibition). Alternatively, potato and banana starch can be heated at higher moisture levels (heat moisture treatment) to produce products with cross-linked performance as is described in patent EP-B-0 436 208. The invention relates to all starch derivatives that can be prepared using these derivatizing techniques.

The starches mentioned in this application can be used alone or in combination.

According to the method of the invention the salt is provided in the form of a solution. In principle any salt can be used, but for applications in food products the salt is preferably NaCl, but any other edible salt can be used, such as KI, KCl, CaSO₄, K₂SO₄, CaCl₂, MgCl₂, CaI₂, or mixtures thereof. The concentration of the salt solution can be from 0.1% to a saturated salt solution. However, it is also possible to use even higher salt concentrations, such as oversaturated salt solutions. Preferably, the salt concentration is at least 1%, more preferably at least 10%. In a highly preferred embodiment, a saturated salt solution is applied.

Mixing of the starch with the salt and water can be performed in a conventional mixer. Typically, the mixing is performed for several minutes, preferably 3-10 minutes. The temperature during mixture can be below 55° C., such as 0-55° C. Normally, the mixing takes place at room temperature. The sequence in which the three components are added to the mixer is not of high importance. In principle, one can choose whatever sequence possible, including adding the three components at the same time, first mixing the starch with the salt and then adding water, first mixing the starch with water and then adding salt, first mixing the salt with water and then adding starch. The preferable sequence is to dissolve the salt in water forming a salt solution and then to add the starch.

According to a preferred embodiment, the mixing is carried out by spraying an aqueous solution comprising the salt over the starch granules. The starch granules are preferably dry, but can have a moisture content of up to 30%.

According to a further embodiment a wet starch (e.g. freshly extracted from the production line of vacuum dehydration) is mixed with a salt solution or fine salt powder.

According to a further embodiment a starch suspension is mixed with dry salt.

Subsequently, the mixture of starch, salt and water is dried, thereby yielding the starch agglomerates.

In case an aqueous salt solution is applied, the weight ratio of starch to salt solution during mixing can be in the range of 1:0.1 to 1:0.7, depending on the concentration of the salt solution. In case of a saturated salt solution, the weight ratio between starch and salt solution is preferably in the range of 1:0.3 to 1:0.5. If the weight ratio between starch and salt solution is lower than 1:0.1 it is difficult to achieve a homogeneous distribution of the starch granules in the salt solution.

In a special embodiment of the invention, the starch is also mixed with a sugar. Sugar also has the ability to bind the starch, so that agglomeration of the starch is increased. Again, the sequence in which the components are added to the mixer is not of high importance. In principle, one can choose whatever sequence possible. For instance, the starch can first be mixed with the salt and the water and thereafter with the sugar. The starch can also be mixed with the sugar and the water first and thereafter with the salt. It is also possible that the salt and sugar are first dissolved in the water after which this solution is mixed with the starch. In another embodiment all components are added to the mixer simultaneously. The preferable sequence is to dissolve the salt and sugar in water forming a solution and then to add the starch.

Any sugar may be used, such as for example glucose, fructose, dextrose, galactose, mannose, sucrose, lactose and/or maltose.

Also other water soluble components may be mixed with the starch, such as maltodextrins or cold soluble starches. These water soluble components assist in the agglomeration of the starch.

After mixing, the mixed composition is dried. The drying can be performed using an oven, a flash dryer, a fluid bed dryer, a spray dryer, a spray cooker, a vacuum dryer, a microwave, a vacuum freeze dryer, a pneumatic dryer, drying with zeolites at elevated temperatures, or by drying in air. Combinations of these drying techniques are also included in the method of the invention. The skilled person is able to operate certain dryers, such as spray dryers of fluid bed dryers to obtain a product with desired properties, such as dispersibility and/or particle size.

Preferably the temperature of the starch during drying does not exceed 60° C., more preferably 50° C. Higher temperatures could be detrimental for the starch. The agglomerated starch is typically dried to a moisture content of less than 30%, preferably less than 25%, more preferably less than 20%, and even more preferably less than 10%.

In order to optimise the dispersibility and/or the particle size the dried starch aggregates can also be subjected to an optional grinding step, preferably after drying. Grinding may for example be carried out by passing the dried starch through a mesh sieve with holes of 200-2000 μm.

The inventors further found that modified starches, such as acetylated starch, oxidised and/or hydroxypropylated starch, can be gelatinized to a certain extent by mixing the starch with a different type of starch (such as native starch or derivatives) and then wetting the mixture with a salt solution. This in contrast to the wetting of native starch with a salt solution, which does not yield gelatinized starch. Without wishing to be bound by theory, the inventors believe that wetting with salt solution causes the modified starch to gelatinize (or to partly gelatinize) and act as a binder in the starch mixture for agglomeration. The inventors surprisingly found that this embodiment results in a starch aggregate that dissolves even better and accordingly results in an even lower degree of lumping.

The modified starch can be mixed with the native starch in quantities from 0.5 to 70% based on dry weight. The wetting can for instance involve spraying or soaking or the like. The ratio of salt solution to starch mixture can be in the range of 0.4:1, preferably 0.6:1. Suitably, a saturated salt solution can be applied. After drying, an agglomerate of a starch mixture and salt is obtained.

In a further aspect the present invention is directed to starch agglomerates obtainable by the method of the invention. In accordance with the method of the invention starch agglomerates are obtained in which substantially all starch granules are covered by salt. The salt is not only present between the agglomerated starch granules, but also inside the fine pores/tunnels of the starch granules. As a result, water easily penetrates into the starch in a homogeneous manner, and thereby reduces or even prevents lump formation.

The resulting starch agglomerates can be applied in a variety of food products. In a further aspect, the invention is therefore directed to a method for preparing a food product using the starch agglomerates of the invention.

In yet another aspect the invention is directed to a food product comprising the starch agglomerates of the invention.

Food products in which the starch agglomerates of the invention can be comprised include for example instant soup, soup, gravy, seasonings, flavour carriers, instant custard, drinks, pre-mixed powder, bakery products, meat products, sauce and sauce binders, noodle preparations, snacks, salty biscuits, and convenience foods. The starch agglomerates of the invention can also be applied in the production of ready meals, canned soups, dairy products, etc. This summary is not intended to limit the field of application, but rather to mention some examples.

In another aspect, the invention is directed to the use of the starch agglomerates of the invention as a viscosifier. It was found that the starch agglomerates can suitably be used as viscosifier to provide a product with the desired viscosity.

The invention will now be further illustrated by the following non-restrictive examples.

### EXAMPLE 1

### Materials

The starches used were common potato starch, amylopectin potato starch and their derivatives. Eliane 100 is a native waxy potato starch and Perfectamyl AC is an acetylated potato starch. The starches and derivatives were obtained from AVEBE. The salt and sugar used in the examples was regular table salt (NaCl) and regular table sugar (sucrose).

### Methods

The lumping was measured by pouring 100 ml of hot water (95° C.) into 2 g (dry base) of starch in a beaker while gently stirring for 1 minute. Then the solution was passed through a 80-mesh sieve. The residues were collected on the sieve and dried. The lumping (%) was calculated according to the following equation.

Lumping(%)=residue(db,g)×100%/2(g)

The viscosity in a model soup was measured using a Brabender Viscograph E (5% starch concentration by weight, torque 700 cmg).

### Agglomeration

The starch was mixed with an approximately saturated salt solution by spraying and mixing. Then the mixture was dried in an oven at about 50° C., until the moisture content of the starch was less than 20%. The dried starch was gently ground by passing it through a mesh sieve with holes of 500 μm. Then, the starch was packed in a sealed bag.

The results are summarized in Table 1.

TABLE 1

| | | | | Final |
|---|---|---|---|---|
| | Lumping | T_{g} | Peak viscosity | viscosity |
| Starch product | (%) | (° C.) | (B.U.) | (B.U.) |
| Eliane 100 | 49.69 | 64.1 | 1575 | 583 |
| Aggl. Eliane 100 | 0.06 | 68.2 | 901 | 380 |
| Perfectamyl AC | 51.26 | 58.9 | 1380 | 750 |
| Aggl. Perfectamyl AC | 0.15 | 63.1 | — | 583 |

After agglomeration the gelatinisation temperature slightly increases. The peak viscosity of the agglomerated starch decreases while the final viscosity does not show a big difference.

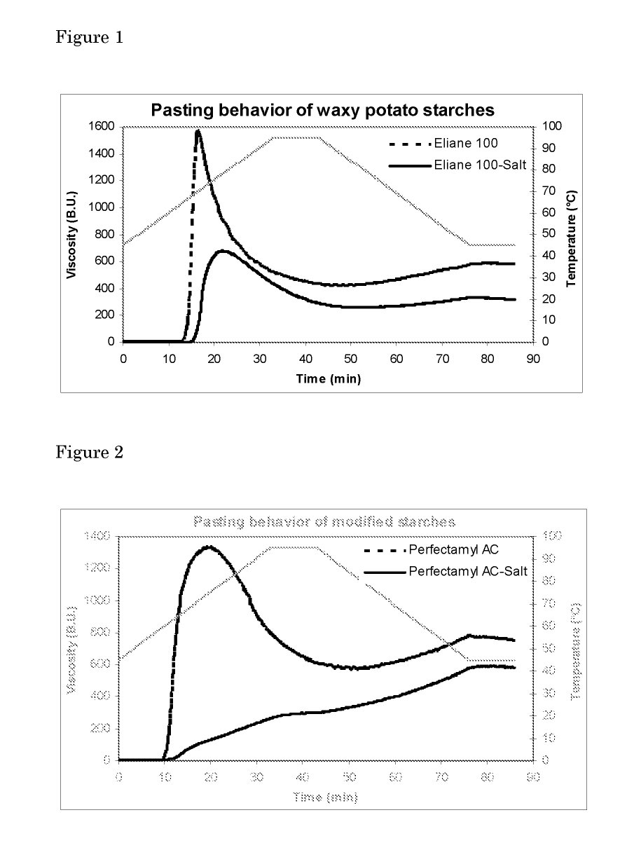

FIG. 1 shows the pasting behavior of waxy potato starch (Eliane 100) versus waxy potato starch agglomerated with salt. FIG. 2 shows the pasting behavior of modified potato starch (Perfectamyl AC) versus native potato starch agglomerated with salt. The grey line shows the viscosity development upon heating and cooling.

### EXAMPLE 2

Two instant soups were prepared using the following ingredients.

| | | | | MSG |
|---|---|---|---|---|
| | Aggl. Eliane 100 | Sugar | Salt | (monosodium |
| | (g) | (g) | (g) | glutamate) (g) |
| Instant Soup 1 | 6.2 | 3.2 | 2.8 | 7.8 |
| Instant Soup 2 | 7.8 | 3.2 | 2.2 | 7.8 |

200 ml of hot water (>90° C.) was poured into the dry mixed powder while gently stirring. In both cases, a homogeneous structure of the soup was obtained without the visual occurrence of lumping.

### EXAMPLE 3

The following three samples were prepared and evaluated.

Sample 1: 1000 g of native potato starch was sprayed with 460 ml of a saturated NaCl solution.

Sample 2: 950 g (95 wt. %) of native potato starch was mixed well with 50 g (5 wt. %) of Perfectamyl AC (acetylated potato starch) obtained from AVEBE. The starch mixture was sprayed with 500 ml of a saturated NaCl solution.

Sample 3: 970 g (97 wt. %) of native potato starch was mixed well with 30 g (3 wt. %) of Perfectamyl A3108 (oxidised potato starch) obtained from AVEBE. The starch mixture was sprayed with 520 ml of a saturated NaCl solution.

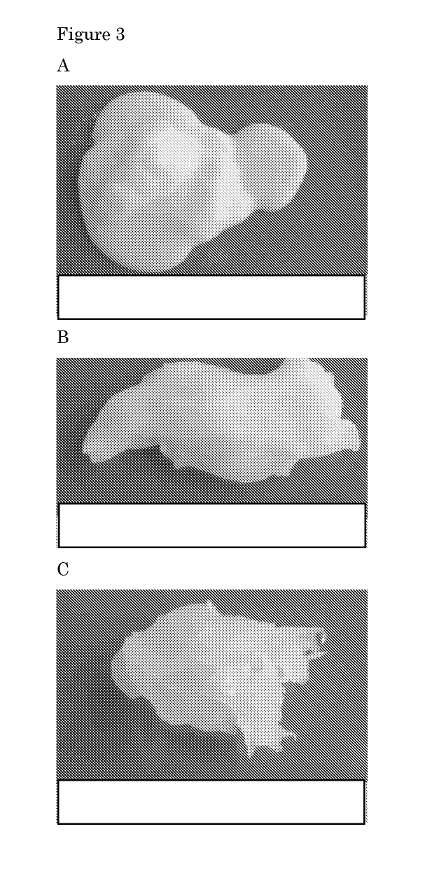

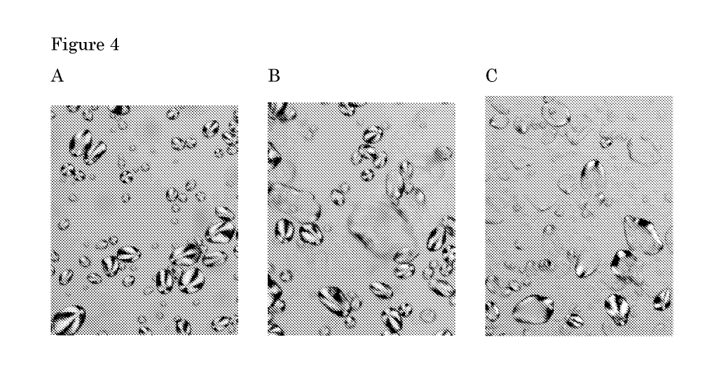

Photographs of the samples sprayed by saturated NaCl solution are shown in FIG. 3 (3A: native potato starch; 3B: Perfectamyl AC; 3C: Perfectamyl A3108). FIG. 4 shows microscopy photographs of the different samples (4A: native potato starch; 4B: Perfectamyl AC; 4C: Perfectamyl A3108). FIGS. 1 and 2 clearly demonstrate that samples 2 and 3 were gelatinized to a certain extent, while the starch of sample 1 did not gelatinize.

After spraying, the starch mixtures of each sample were extruded through a No. 30-mesh sieve (holes of 595 μm) and then air-dried at 40° C. until the starch mixture had a moisture content below 18%.

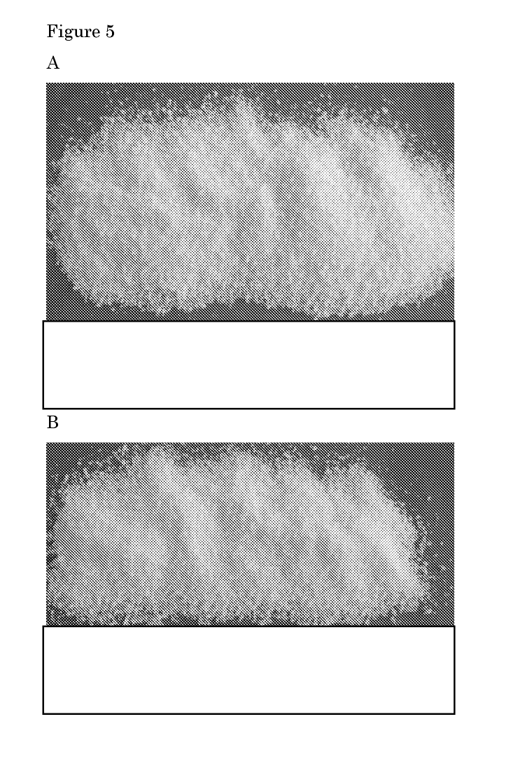

The final agglomerated starches of samples 2 and 3 are shown in FIG. 5 (5A: mixture of native potato starch with Perfectamyl AC; 5B: mixture of native potato starch with Perfectamyl A3108).

The gelatinisation temperature and the peak viscosity temperature were measured by a Brabender Viscograph and the results are shown in Table 1. The main purpose of agglomeration is to avoid or decrease the lumping problems of starches or starchy products when prepared in hot water of solutions (such as instant soup). Lumping was measured by pouring 2 g (dry base) of starch gently into 100 ml of hot water (95° C.) in a beaker while gently stirring for 1 minute. Then the solution was passed through a 80-mesh sieve (holes of 180 μm). The residues were collected on the sieve and dried. The lumping (%) was calculated according to the following equation

$$Lumping ( \% ) = \frac{residue ( db , g ) \times 100 \%}{2 ( g )}$$

The results are shown in Table 2.

TABLE 2
Physical properties of the agglomerated starch compared
with that of typical agglomeration starch.

| | | | Tg | | Tp | Time |
|---|---|---|---|---|---|---|
| Agglomerated | Lumping | Tg^{b} | time^{c} | Tp^{d} | time^{e} | difference^{f} |
| starch | (%) | (° C.) | (min) | (° C.) | (min) | (min) |
| Granamyl P13^{a} | 4.7 | 62.2 | 12.42 | 79.4 | 23.5 | 11.08 |
| 97% NPS^{g} + 3% | 0 | 68.8 | 16.67 | 94.5 | 37.17 | 20.50 |
| Perfectamyl A | | | | | | |
| 3108^{h} 6% Aggl | | | | | | |

^{a}Granamyl P13 is an agglomerated native potato starch prepared by a typical agglomeration method (the starch is agglomerated by spraying it with a maltodextrin solution in a fluid bed)
^{b}Tg is gelatinisation temperature
^{c}Tg time is the time when gelatinisation starts
^{d}Tp is the temperature when the peak viscosity is reached
^{e}Tp time is the time when the peak viscosity is reached
^{f}Time difference is the time between reaching the peak viscosity and the time when gelatinisation starts
^{g}NPS is native potato starch
^{h}Perfectamyl A3108 is oxidised potato starch

It was found that even agglomerated starch still can not completely avoid lumping (the lumping ratio is 4.7%, while the lumping ratio of normal starch without agglomeration is more than 40%) A mixture of native potato starch with a modified starch (Perfectamyl A3108), however, did not result in any lumping.

The gelatinisation temperature of the agglomerated mixture is slightly higher and the time difference is much higher than that of Granamyl P13. This indicates that the agglomerated mixture of starch will take water to swell and gelatinize slowly which will avoid the outside starch to gelatinize too quickly. Rapid gelatinisation of the outside starch will encapture and prevent inside starch to absorb water for gelatinisation which results in lumping. This may be the reason why the agglomerated mixture better avoids lumping.

### EXAMPLE 4

The lumping ratio of different starch agglomerates (native, chemically modified, physically modified, and regelatinised starches) was tested. The starch agglomerates were prepared using a saturated solution of NaCl. The results are shown in Table 3.

TABLE 3
Lumping results for different starch agglomerates.

| | Lumping |
|---|---|
| Salt/starch agglomerate | (%) |
| 10% Perfectamyl AC^{a} + 90% NPS^{b} | 0.08 |
| Farinex AG600^{c} | 0.12 |
| Paselli WA4^{d} | 0.18 |
| Eliane C100^{e} | 0.21 |
| Prejel VA70^{f} | 0.19 |
| Pregelatinised corn starch | 0.27 |
| Pregelatinised tapioca starch | 0.31 |
| Pea starch | 0.22 |

^{a}Perfectamyl AC is acetylated potato starch
^{b}NPS is native potato starch
^{c}Farinex AG600 is hydroxypropylated potato starch
^{d}Paselli WA4 is pregelatinised potato starch
^{e}Eliane C100 is pregelatinised waxy potato starch
^{f}Prejel VA70 is pregelatinised hydroxypropyl distarch phosphate potato starch

1. Method for the preparation of agglomerated starch, comprising
mixing of starch with a salt and water; and
drying the mixture.

2. Method according to claim 1, wherein said starch is further mixed with a sugar.

3. Method according to claim 1, wherein said starch and water are provided in the form of an aqueous starch suspension.

4. Method according to claim 1, wherein said salt and water are provided in the form of an aqueous solution comprising the salt.

5. Method according to claim 3, wherein the aqueous solution has a salt concentration of at least 1%, more preferably at least 10%, and most preferably a saturated salt solution.

6. Method according to claim 4, wherein said mixing comprises spraying the aqueous solution comprising a salt over the starch.

7. Method according to claim 1, wherein the dried mixture is ground.

8. Method according to claim 1, wherein said drying comprises the use of an oven, a flash dryer, a fluid bed dryer, a spray dryer, a spray cooker, a vacuum dryer, a microwave, a vacuum freeze dryer, a pneumatic dryer, drying with zeolites at elevated temperatures, or by drying in air.

9. Method according to claim 1, wherein said salt is NaCl.

10. Method according to claim 1, wherein the starch is selected from the group consisting of maize starch, barley starch, wheat starch, rice starch, triticale starch, millet starch, tapioca starch, arrow root starch, banana starch, potato starch, sweet potato starch, sago starch, mung bean starch, and pea starch.

11. Method according to claim 1, wherein the starch is a starch derivative, such as a cross-linked starch, oxidised starch, etherified starch, esterified starch, dry roasted starch, or dextrinised starch.

12. Method according to claim 1, wherein said starch is a starch mixture comprising a modified starch, such as acetylated starch, oxidised and/or hydroxypropylated starch, and a different type of starch, such as native starch or a derivatised starch.

13. Method according to claim 12, wherein the amount of modified starch in the starch mixture is from 0.5 to 70% based on dry weight.

14. Agglomerated starch obtainable by a method according to claim 1.

15. Food product comprising agglomerated starch in accordance with claim 14.

16. Method of preparing a food product comprising using an agglomerated starch according to claim 14.

17. Food product obtainable according to the method of claim 16.

18. Food product according to claim 15 in the form of an instant soup, a soup, gravy, a seasoning, a flavour carrier, an instant custard, a drink, a pre-mixed powder, a bakery product, a meat product, a sauce, a sauce binder, a noodle preparation, a snack, a salty biscuit, or a convenience food.

19. Use of an agglomerated starch in accordance with claim 14 as a viscosifier.
